(19) United States
(12) Patent Application Publication
(10) Pub. No.: US 2025/0187958 A1
(43) Pub. Date: Jun. 12, 2025

(54) SOLID BACTERIAL GROWTH SUPPORT FOR WASTEWATER TREATMENT, METHODS AND USES THEREOF

(71) Applicant: Technologies ECOFIXE Inc., Laval (CA)

(72) Inventor: Marisol LABRECQUE, Ste-Marthe-sur-Lac (CA)

(21) Appl. No.: 18/949,424

(22) Filed: Nov. 15, 2024

Related U.S. Application Data
(63) Continuation of application No. 17/626,140, filed on Jan. 11, 2022, now abandoned.
(60) Provisional application No. 62/873,853, filed on Jul. 13, 2019.

(51) Int. Cl. C02F 3/10; C02F 101/16; C02F 101/30

(52) U.S. Cl. CPC C02F 3/101; C02F 3/107; C02F 3/108; C02F 3/109; C02F 2101/16; C02F 2101/30

(57) ABSTRACT

The present invention provides solid bacterial growth support for wastewater treatment comprising microparticles coupled to and partly inserted on at least one surface thereof and having a microparticle coverage of about 20% to 100% of total surface of the solid bacterial growth support, and providing a biomass development surface at least about 1.57 times larger than the contact surface of a solid bacterial growth support without microparticles. The present invention also provides methods of using the solid bacterial growth support for wastewater treatment.

### CROSS-REFERENCE TO RELATED APPLICATIONS

This application is a continuation application of U.S. Patent Application Ser. No. 17/626,140, filed on Jan. 11, 2022, which is a U.S. National Phase application under 35 USC § 371 of PCT/CA2020/050972, filed on Jul. 13, 2020, which claims priority from and the benefit of U.S. Provisional Patent Application No. 62/873,853, filed on Jul. 13, 2019, the specifications of which are hereby incorporated by reference in their entireties.

### BACKGROUND

### (a) Field

The subject matter disclosed generally relates to a solid bacterial growth support for wastewater treatment, and methods of use thereof. More specifically, the subject matter relates to a solid bacterial growth support for the removal of organic and inorganic elements contaminating wastewater.

### (b) Related Prior Art

Water contamination is a widespread problem around the world which can be attributed in part to urban sprawling and industrial development along waterway systems. In order to protect the environment and promote public health, communities typically require wastewater treatment. In fact, wastewater treatment has long been the subject of technical inquiry and practical application due not only to the continuing need for clean water but also due to the cost of water usage and discharge.

Untreated wastewater contains relatively high concentrations of organics and non-organics load, ammonia nitrogen, phosphorus, suspended and dissolved solids that, if left untreated and not removed from the waste stream, can result in environmental pollution. To treat wastewater, communities in highly populated areas commonly collect wastewater and transport it through a series of underground pipes to wastewater treatment plants.

However, these wastewater treatment plants have a maximum capacity for treating wastewater. Once the maximum capacity is reached, it is not possible to treat effectively and efficiently further volumes of incoming wastewater and/or further contaminants load in the incoming wastewater. Thus, the performance of these wastewater treatment plants may be inadequate on several levels. For instance, the capacity of these wastewater treatment plants to treat the wastewater is typically altered by heavy rains, or other massive flow of water into their environment. Consequently, the incoming overflow of water causes the beneficial bacteria and biomass to be washed out of the wastewater treatment plants, which greatly reduces their treatment performance.

Therefore, there is a need for a wastewater treatment device and method that would improve and/or stabilize the treatment performance of wastewater treatment plants.

### SUMMARY

According to an embodiment, there is provided a solid bacterial growth support for wastewater treatment, comprising a body comprising at least one surface comprising a plurality of microparticles coupled to and partly inserted on the at least one surface, the plurality of microparticles having a microparticle coverage of about 20% to 100% of total surface of the solid bacterial growth support, providing a biomass development surface of about 1.57 to 10 times larger than the biomass development surface of the body without microparticles.

The microparticles may have a diameter of about 1 to about 50 μm.

The microparticles may comprise a hollow microparticle, a full microparticle, or a combination thereof.

The microparticles may comprise a plurality of pores and/or asperities on a surface thereof.

The solid bacterial growth support may comprise a plurality of surfaces.

The microparticle coverage may be at least 50% of total surface for the removal of ammonia nitrogen in the wastewater.

The microparticle coverage may be up to about 50% of total surface for the removal of the organic load in the wastewater.

The solid bacterial growth support may provide a biomass development surface of about 100 to 1000 m²/m³ when in use as a fixed bed bacterial support.

The solid bacterial growth support may provide a biomass development surface of about 300 to 3000 m²/m³ when in use as a fluidized bed bacterial support.

The solid bacterial growth support may be made of plastic, carbonized bone powder, a proteinaceous matter, or a combination thereof.

The plastic may be selected from the group consisting of a polyethylene, a polyethylene terephthalate, and a polyvinyl chloride.

The proteinaceous matter may comprise casein, whey, rice protein, hemp protein, insect protein, seaweed protein and combinations thereof.

The solid bacterial growth support may be made in part or in whole of recycled plastic.

The microparticles may be made of a mineral material or a polymer.

The microparticles may be a combination of microparticles made of a mineral material or a polymer. The mineral may be a silica. The microparticles may be silica microparticles. The silica microparticles may have a diameter of about 1 to about 50 μm. The biomass development surface is from about 2 to about 6 times larger than the biomass development surface of the body without microparticles.

The body may be a plurality of mesh hollow bodies, each hollow body having an external and an internal surface, and a plurality of openings therethrough configured to permit circulation of a fluid, the mesh hollow bodies being substantially elongated and configured parallel to one another along their length to form the solid bacterial growth support and provide an exterior surface of the bacterial growth support, and the plurality of microparticles is coupled to and partly inserted on the exterior surface of the solid bacterial growth support and on the external and the internal surface of the mesh hollow bodies.

The hollow body may be a cylinder, a rectangular prism, a rectangular cuboid, a triangular prism, or a combination thereof. The hollow body may be a cylinder.

The plurality of mesh hollow body may form a block-shaped solid bacterial growth support.

The plurality of mesh hollow body may comprise about 100 to 300 of the mesh hollow body.

The mesh hollow body is a cylinder having a diameter of about 1 to 3 cm.

The length may be from about 50 to about 100 cm.

According to another embodiment, there is provided wastewater treatment system comprising a solid bacterial growth support of the present invention, in an enclosure.

The wastewater treatment system of the present invention may comprise a plurality of the solid bacterial growth support may comprise a submerged fixed bed system, a fluidized system, or a combination thereof.

The wastewater treatment system may further comprise an aeration system to promote growth of biomass, avoid clogging of the solid bacterial growth support and enhance the dispersion of the biomass inside and outside the treatment unit.

According to another embodiment, there is provided method for wastewater treatment using the solid bacterial growth support of the present invention, comprising contacting wastewater with a plurality of the solid bacterial growth support, or a system according to the present invention, placed in an enclosure to be held together to form a treatment unit, the treatment unit having a size dependent on the flow rate and contaminant loads in the wastewater.

The solid bacterial growth support may be used in a submerged fixed bed or a fluidized system.

The solid bacterial growth support or the wastewater treatment system may be submerged in a first treatment aerated pond or lagoon for organic load removal.

The solid bacterial growth support or the wastewater treatment system may be installed in the last aerated zone of a treatment aerated pond or lagoon for ammoniacal nitrogen load removal.

The solid bacterial growth support may be used in combination with an aeration system to promote growth of biomass, avoid clogging of the solid bacterial growth support and enhance the dispersion of the biomass inside and outside the treatment unit.

The solid bacterial growth support may increase the rate of biomass growth in wastewater by at least about 50% in comparison to the rate of biomass growth in wastewater without the solid bacterial growth support.

The solid bacterial growth support may provide an organic load abatement capacity of at least about 41% (kg/day) higher than an organic load abatement capacity of a solid bacterial growth support without microparticles.

The solid bacterial growth support may have a microparticle coverage of at least about 50% of total surface for the removal of ammoniacal nitrogen load in the wastewater.

The solid bacterial growth support may have a microparticle coverage of about 20% and up to about 50% of total surface for the removal of organic load in the wastewater.

The solid bacterial growth support may provide an ammonia nitrogen removal capacity of at least about 62% (kg/day) higher than an ammonia nitrogen removal capacity of a solid bacterial growth support without microparticles.

The solid bacterial growth support may be submerged in the last third of a first aerated treatment pond or lagoon of a water treatment plant to remove the organic load.

The method may be for removal of up to 98% of a 5 day biochemical oxygen demand (BOD5) load.

The method may be for treatment of BOD5 of about 150 mg/L up to about 20 000 mg/L.

The method may be for removal of up to 99% of a total suspended solids (TSS) load.

The solid bacterial growth support may be submerged in an anoxic portion of a pond or lagoon of a water treatment plant for the removal of ammonia nitrogen load.

The method may be for removal of up to 99% of an ammonia nitrogen load.

The method may be for treatment of ammoniacal nitrogen of from about 1 mg/L up to about 50 mg/L.

The method may be performed in liquid water at a temperature of about 0° C. to about 40° C., preferably at a temperature of from about 3° C. to about 20° C.

The following terms are defined below.

The term “growth support” is intended to mean a solid substrate having defined two and/or three-dimensional shapes and structures, which may be filled or hollow, and are made of a material that is compatible with bacterial, microorganismal and biomass growth. The “solid bacterial growth support” as used in the present invention provides sufficient surface area and support for bacterial, microorganismal and biomass growth.

The terms “microorganism” or “live microorganism” is intended to mean the collective quantity of (live) bacteria, and (live) biomass in the system of the present invention.

The term “microparticle” is intended to mean particle of microscopic size, preferably having diameters of 1 to about 50 μm. The microparticles may be of any shape, such as spheres, ovoid, spheroid, ellipsoid, oblong, oblate, tube, rod, star, pyramidal, triangular, square, trapeze, etc. The microparticles may be full or hollow, and they may comprise pores or asperities.

The term “hollow body” or “hollow bodies” is intended to mean that it/they have a space inside it, as opposed to being solid all the way through.

The term “mesh” is intended to mean that the hollow body or bodies used in the present invention are made from a network of wire (or wire-like) or thread (or thread-like) material.

The terms “microparticle coverage” or “microparticle surface coverage” is intended to refer to the number of adsorbed, coupled to, and/or partly inserted microparticles on the total surface of the solid bacterial growth support.

The term “density of microparticles” or “microparticle density” is intended to mean the number of microparticles per mm² of surface.

The term “specific surface area” or SSA is intended to mean the property of solids defined as the total surface area of a material per unit of mass, (with units of m²/kg or m²/g) or solid or bulk volume (units of m²/m³ or m⁻¹).

The term “biomass development surface” is intended to mean, in the context of the present invention, the surface area available on a solid bacterial growth support. The solid bacterial growth support of the present invention provides increase biomass development surface from the presence of microparticles versus the biomass development surface of a solid bacterial growth support having the same shape but lacking microparticles. For example, a biomass development surface of 2 refers to a solid bacterial growth support having twice the biomass development surface available for contact than an equivalent solid bacterial growth support having the same shape but lacking microparticles.

Before describing the present invention in detail, a number of terms will be defined. As used herein, the singular forms “a”, “an”, and “the” are employed to describe elements and components of the invention and include plural referents unless the context clearly dictates otherwise. This is done merely for convenience and to give a general sense of the invention. This description should be read to include one or at least one and the singular also includes the plural unless it is obvious that it is meant otherwise.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. However, the above definitions refer to the particular embodiments described herein and are not to be taken as limiting; the invention includes equivalents for other undescribed embodiments. In addition, the materials, methods, and examples are illustrative only and not intended to be limiting.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates a representative picture of a perspective view of a solid bacterial growth support comprising a plurality of mesh cylinders, the mesh cylinders are assembled to form a block-shaped element, according to an embodiment of the present invention.

FIG. 2 illustrates a schematic representation of a perspective view of a solid bacterial growth support comprising a plurality of mesh cylinders, the mesh cylinders having a plurality of openings in which water can flow freely through the solid bacterial growth support, according to an embodiment of the present invention.

FIG. 3 illustrates the mesh cylinders that may be coated with microparticles as embodiments of the bacterial growth support of the present invention,

FIG. 4 illustrates fluidized solid bacterial growth support that may be coated with microparticles as embodiments of the bacterial growth support of the present invention. The embodiments shown have varying fixed diameter.

FIG. 5 illustrates a fluidized solid bacterial growth support that may be coated with microparticles as embodiments of the bacterial growth support of the present invention. The embodiments shown has a variable diameter.

FIG. 6 illustrates the removal of ammoniacal nitrogen over a 12-month period with a system comprising a solid bacterial growth support, according to an embodiment of the present invention.

FIG. 7 illustrates the removal of ammoniacal nitrogen over a 12-month period. There are no wastewater treatment systems in these aerated ponds.

FIG. 8A illustrates a plan view of the radiation treatment effect provided by a system of the present invention, which shows the impact on the flow velocity through the system of the present invention.

FIG. 8B illustrates a sectional view of the radiation treatment effect provided by a system of the present invention, which shows the impact on the flow velocity through the system of the present invention.

It will be noted that throughout the appended drawings, like features are identified by like reference numerals.

### DETAILED DESCRIPTION

In embodiments there is disclosed a solid bacterial growth support for wastewater treatment, methods and uses thereof.

According to an embodiment, there is disclosed a solid bacterial growth support for wastewater treatment which comprises a body comprising at least one surface comprising a plurality of microparticles coupled to and partly inserted on the at least one surface. The plurality of microparticles have a microparticle coverage of about 20% to 100%, which represents between about 80 to 800 000 microparticles/mm² of total surface of the solid bacterial growth support and provide a biomass development surface about 1.57 to about 10, or about 1.6 to about 10, or about 1.7 to about 10, or about 1.8 to about 10, or about 1.9 to about 10, or about 2 to about 10, or about 3 to about 10, or about 4 to about 10, or about 5 to about 10, or about 6 to about 10, or about 7 to about 10, or about 8 to about 10, or about 9 to about 10, or about 1.57 to about 9, or about 1.6 to about 9, or about 1.7 to about 9, or about 1.8 to about 9, or about 1.9 to about 9, or about 2 to about 9, or about 3 to about 9, or about 4 to about 9, or about 5 to about 9, or about 6 to about 9, or about 7 to about 9, or about 8 to about 9, or about 1.57 to about 8, or about 1.6 to about 8, or about 1.7 to about 8, or about 1.8 to about 8, or about 1.9 to about 8, or about 2 to about 8, or about 3 to about 8, or about 4 to about 8, or about 5 to about 8, or about 6 to about 8, or about 7 to about 8, or about 1.57 to about 7, or about 1.6 to about 7, or about 1.7 to about 7, or about 1.8 to about 7, or about 1.9 to about 7, or about 2 to about 7, or about 3 to about 7, or about 4 to about 7, or about 5 to about 7, or about 6 to about 7, or about 1.57 to about 6, or about 1.6 to about 6, or about 1.7 to about 6, or about 1.8 to about 6, or about 1.9 to about 6, or about 2 to about 6, or about 3 to about 6, or about 4 to about 6, or about 5 to about 6, or about 1.57 to about 5, or about 1.6 to about 5, or about 1.7 to about 5, or about 1.8 to about 5, or about 1.9 to about 5, or about 2 to about 5, or about 3 to about 5, or about 4 to about 5, or about 1.57 to about 4, or about 1.6 to about 4, or about 1.7 to about 4, or about 1.8 to about 4, or about 1.9 to about 4, or about 2 to about 4, or about 3 to about 4, or about 1.57 to about 3, or about 1.6 to about 3, or about 1.7 to about 3, or about 1.8 to about 3, or about 1.9 to about 3, or about 2 to about 3, or about 1.57 to about 2, or about 1.6 to about 2, or about 1.7 to about 2, or about 1.8 to about 2, or about 1.9 to about 2 times larger than the biomass development surface of a solid bacterial growth support without microparticles, and preferably from about 2 to about 6 times larger than the biomass development surface of a solid bacterial growth support without microparticles.

According to an embodiment, the bacterial growth support may be used as a fixed bed of bacterial growth support and can provide a biomass development surface between about 100 to about 1000 m²/m³, or about 200 to about 1000 m²/m³, or about 300 to about 1000 m²/m³, or about 400 to about 1000 m²/m³, or about 500 to about 1000 m²/m³, or about 600 to about 1000 m²/m³, or about 700 to about 1000 m²/m³, or about 800 to about 1000 m²/m³, or about 900 to about 1000 m²/m³, or about 100 to about 900 m²/m³, or about 200 to about 900 m²/m³, or about 300 to about 900 m²/m³, or about 400 to about 900 m²/m³, or about 500 to about 900 m²/m³, or about 600 to about 900 m²/m³, or about 700 to about 900 m²/m³, or about 800 to about 900 m²/m³, or about 100 to about 800 m²/m³, or about 200 to about 800 m²/m³, or about 300 to about 800 m²/m³, or about 400 to about 800 m²/m³, or about 500 to about 800 m²/m³, or about 600 to about 800 m²/m³, or about 700 to about 800 m²/m³, or about 100 to about 700 m²/m³, or about 200 to about 700 m²/m³, or about 300 to about 700 m²/m³, or about 400 to about 700 m²/m³, or about 500 to about 700 m²/m³, or about 600 to about 700 m²/m³, or about 100 to about 600 m²/m³, or about 200 to about 600 m²/m³, or about 300 to about 600 m²/m³, or about 400 to about 600 m²/m³, or about 500 to about 600 m²/m³, or about 100 to about 500 m²/m³, or about 200 to about 500 m²/m³, or about 300 to about 500 m²/m³, or about 400 to about 500 m²/m³, or about 100 to about 400 m²/m³, or about 200 to about 400 m²/m³, or about 300 to about 400 m²/m³, or about 100 to about 300 m²/m³, or about 200 to about 300 m²/m³, or about 100 to about 200 m²/m³.

According to an embodiment, the bacterial growth support may be used in a fluidized bed and can provide a biomass development surface between about 300 to about 3000 m²/m³, or about 400 to about 3000 m²/m³, or 400 to about 3000 m²/m³, or 500 to about 3000 m²/m³, or 600 to about 3000 m²/m³, or 700 to about 3000 m²/m³, or 800 to about 3000 m²/m³, or 900 to about 3000 m²/m³, or 1000 to about 3000 m²/m³, or 1250 to about 3000 m²/m³, or 1500 to about 3000 m²/m³, or 1750 to about 3000 m²/m³, or 2000 to about 3000 m²/m³, or 2250 to about 3000 m²/m³, or 2500 to about 3000 m²/m³, or 2750 to about 3000 m²/m³, or about 300 to about 2750 m²/m³, or about 400 to about 2750 m²/m³, or 400 to about 2750 m²/m³, or 500 to about 2750 m²/m³, or 600 to about 2750 m²/m³, or 700 to about 2750 m²/m³, or 800 to about 2750 m²/m³, or 900 to about 2750 m²/m³, or 1000 to about 2750 m²/m³, or 1250 to about 2750 m²/m³, or 1500 to about 2750 m²/m³, or 1750 to about 2750 m²/m³, or 2000 to about 2750 m²/m³, or 2250 to about 2750 m²/m³, or 2500 to about 2750 m²/m³, or about 300 to about 2500 m²/m³, or about 400 to about 2500 m²/m³, or 400 to about 2500 m²/m³, or 500 to about 2500 m²/m³, or 600 to about 2500 m²/m³, or 700 to about 2500 m²/m³, or 800 to about 2500 m²/m³, or 900 to about 2500 m²/m³, or 1000 to about 2500 m²/m³, or 1250 to about 2500 m²/m³, or 1500 to about 2500 m²/m³, or 1750 to about 2500 m²/m³, or 2000 to about 2500 m²/m³, or 2250 to about 2500 m²/m³, or about 300 to about 2250 m²/m³, or about 400 to about 2250 m²/m³, or 400 to about 2250 m²/m³, or 500 to about 2250 m²/m³, or 600 to about 2250 m²/m³, or 700 to about 2250 m²/m³, or 800 to about 2250 m²/m³, or 900 to about 2250 m²/m³, or 1000 to about 2250 m²/m³, or 1250 to about 2250 m²/m³, or 1500 to about 2250 m²/m³, or 1750 to about 2250 m²/m³, or 2000 to about 2250 m²/m³, or about 300 to about 2000 m²/m³, or about 400 to about 2000 m²/m³, or 400 to about 2000 m²/m³, or 500 to about 2000 m²/m³, or 600 to about 2000 m²/m³, or 700 to about 2000 m²/m³, or 800 to about 2000 m²/m³, or 900 to about 2000 m²/m³, or 1000 to about 2000 m²/m³, or 1250 to about 2000 m²/m³, or 1500 to about 2000 m²/m³, or 1750 to about 2000 m²/m³, or about 300 to about 1750 m²/m³, or about 400 to about 1750 m²/m³, or 400 to about 1750 m²/m³, or 500 to about 1750 m²/m³, or 600 to about 1750 m²/m³, or 700 to about 1750 m²/m³, or 800 to about 1750 m²/m³, or 900 to about 1750 m²/m³, or 1000 to about 1750 m²/m³, or 1250 to about 1750 m²/m³, or 1500 to about 1750 m²/m³, or about 300 to about 1500 m²/m³, or about 400 to about 1500 m²/m³, or 400 to about 1500 m²/m³, or 500 to about 1500 m²/m³, or 600 to about 1500 m²/m³, or 700 to about 1500 m²/m³, or 800 to about 1500 m²/m³, or 900 to about 1500 m²/m³, or 1000 to about 1500 m²/m³, or 1250 to about 1500 m²/m³, or about 300 to about 1250 m²/m³, or about 400 to about 1250 m²/m³, or 400 to about 1250 m²/m³, or 500 to about 1250 m²/m³, or 600 to about 1250 m²/m³, or 700 to about 1500 m²/m³, or 800 to about 1250 m²/m³, or 900 to about 1250 m²/m³, or 1000 to about 1250 m²/m³, or about 300 to about 1000 m²/m³, or about 400 to about 1000 m²/m³, or 400 to about 1000 m²/m³, or 500 to about 1000 m²/m³, or 600 to about 1000 m²/m³, or 700 to about 1000 m²/m³, or 800 to about 1000 m²/m³, or 900to about 1000 m²/m³, or about 300 to about 1000 m²/m³, or about 400 to about 1000 m²/m³, or 400 to about 1000 m²/m³, or 500 to about 1000 m²/m³, or 600 to about 1000 m²/m³, or 700 to about 1000 m²/m³, or 800 to about 1000 m²/m³.

The solid bacterial growth support may be used for providing surprising treatment results in terms of capacity and also in terms of what biological matter or chemical is being removed from the wastewater, in comparison with fluidized bacterial growth media.

According to an embodiment, there is disclosed a solid bacterial growth support for wastewater treatment which comprises a plurality of mesh hollow bodies. Each hollow body has an external and an internal surface, and a plurality of openings through the external and an internal surfaces, which are configured to permit circulation of a fluid (i.e. the wastewater being treated). The mesh hollow bodies are substantially elongated and configured parallel to one another along their length to form the solid bacterial growth support and provide an exterior surface of the bacterial growth support. A plurality of microparticles are coupled to and partly inserted on the exterior surface of the solid bacterial growth support and on the external and internal surfaces of the mesh hollow bodies.

In embodiment, the hollow body may be a cyclinder (of round or eliptic cross-section), a rectangular prism (i.e. having a rectangular cross-section), a rectangular cuboid (i.e. having a square cross-section), a triangular prism (i.e. having a triangular cross-section), or a combination thereof.

As used herein, the term mesh hollow body or hollow bodies is intended to mean that the hollow bodies have a space inside, as opposed to being solid all the way through and that they are made from a network of wire (or wire-like) or thread (or thread-like) material. In embodiments, the mesh hollow bodies may have been shaped prior to assembly into the solid bacterial growth support. In another embodiment, the mesh hollow bodies may be assembled from mesh material (e.g. wires or threads of some kind) which are formed or assembled directly into the solid bacterial growth, without prior formation of the individual the mesh hollow bodies repeating units.

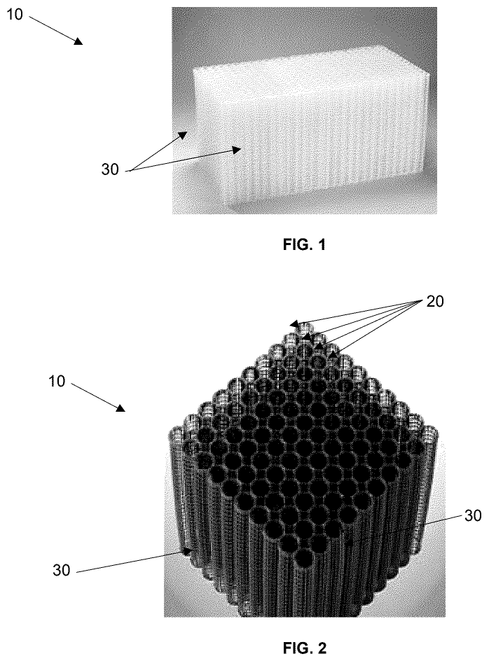

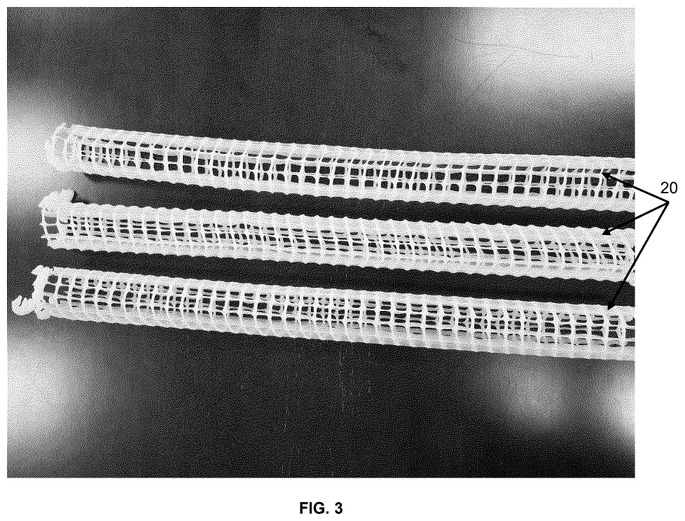

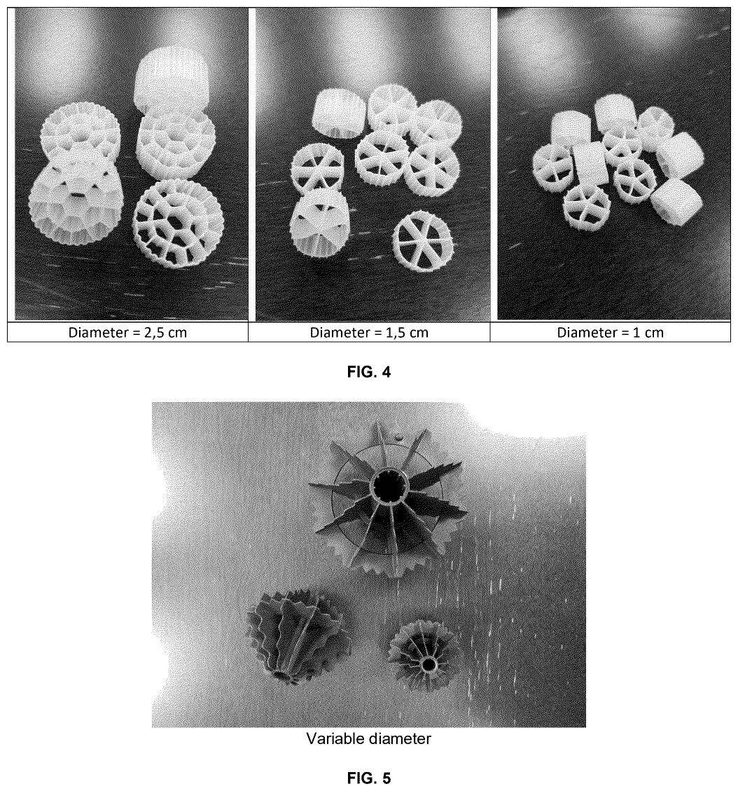

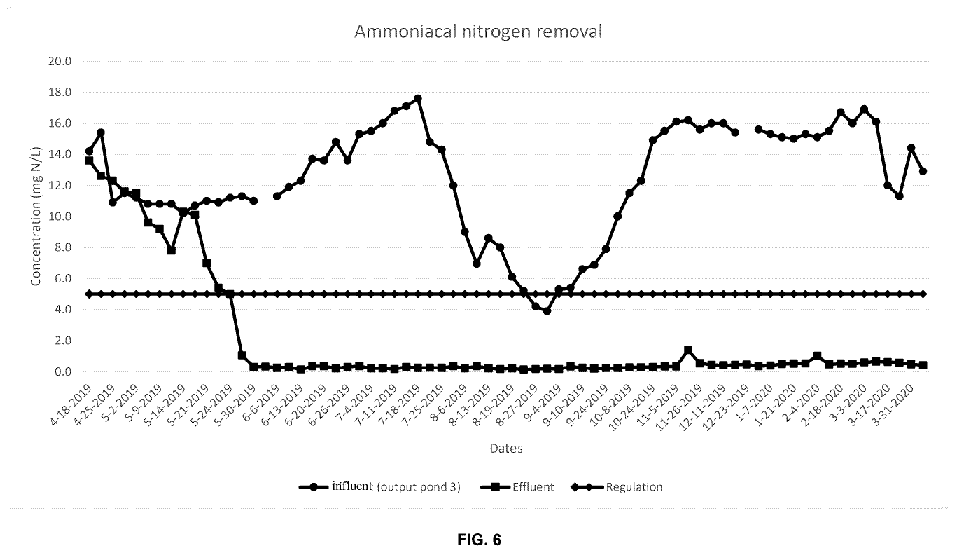

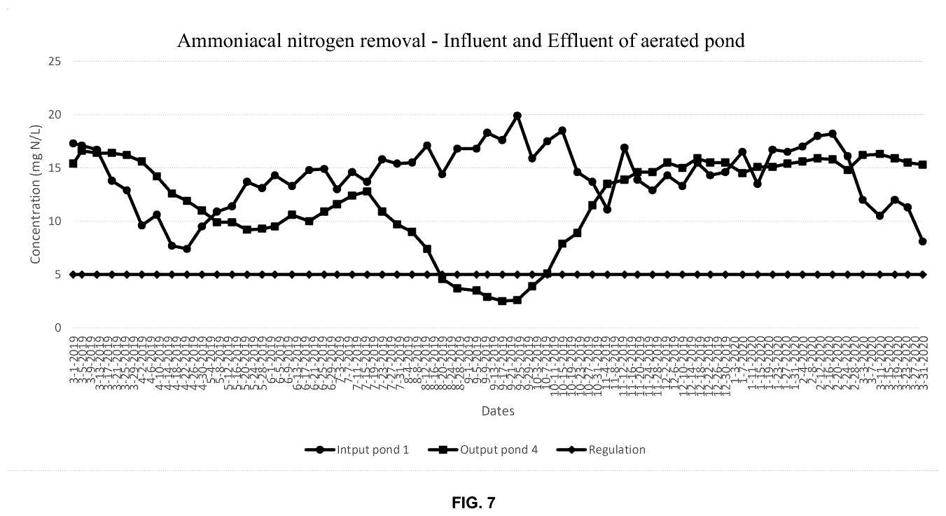

Referring now to the drawings, and more particularly to FIGS. 1 and 2, there is shown an embodiment of a solid bacterial growth support 10 comprising a plurality of mesh hollow bodies, in this case mesh cylinders 20. The mesh cylinders 20 are substantially parallel to one another along their length to form a solid bacterial growth support (in this case, block-shaped), providing an exterior surface 30 to the solid bacterial growth support 10 on which microparticles are coupled or inserted. The microparticles may also be coupled or inserted on an inside surface of the mesh cylinders 20 of the solid bacterial growth support 10.

Now referring to FIG. 2, there is shown an embodiment of a solid bacterial growth support 10 comprising a plurality of mesh cylinders 20 having a plurality of openings on a surface thereof. Wastewater can flow freely through the block-shaped solid bacterial growth support through the numerous openings in each mesh cylinder.

The solid bacterial growth support 10 may comprise about 100 to 300 mesh cylinders 20. Each of the mesh cylinders 20 may have a diameter of about 1 to 3 cm and a length of about 50 to 100 cm.

The solid bacterial growth support 10 may be made of plastic, carbonized bone powder, proteinaceous matter, or a combination thereof. The plastic may be selected from the group consisting of a polyethylene, a polyethylene terephthalate, and a polyvinyl chloride. In embodiments, the proteinaceous matter may comprise casein, whey, rice protein, hemp protein, insect protein, seaweed protein and combinations thereof. The solid bacterial growth support may be made in part or in whole of recycled plastic.

The microparticles may have a diameter of about 1 to about 50 μm. The microparticles may be hollow microparticles or full microparticles, or combination thereof. The microparticles may comprise a plurality of pores and/or asperities on the surface thereof. The microparticles may be sprayed onto solid bacterial growth support 10, resulting in coating of the exterior surface 30 thereof as well as coating of the inside surface of the mesh cylinders 20. Alternatively, the solid bacterial growth support 10, or the individual mesh cylinders may be contacted directly in a powder of the microparticles prior to cooling of the material (during manufacturing), resulting in adhesion and/or insertion of the microparticles on the contacted surfaces. In another embodiment, the microparticles may be sprayed onto the individual mesh cylinders prior to their assembly into solid bacterial growth supports. In another embodiment, the microparticles may be incorporated into the mixture or compound used to manufacture the solid bacterial growth support 10 of the present invention. According to an embodiment, the microparticle coverage may be of about 20% to about 100%, or about 25% to about 100%, or about 30% to about 100%, or about 35% to about 100%, or about 40% to about 100%, or about 45% to about 100%, or about 50% to about 100%, or about 55% to about 100%, or about 60% to about 100%, or about 65% to about 100%, or about 70% to about 100%, or about 75% to about 100%, or about 80% to about 100%, or about 85% to about 100%, or about 90% to about 100%, or about 95% to about 100%, or 20% to about 95%, or about 25% to about 95%, or about 30% to about 95%, or about 35% to about 95%, or about 40% to about 95%, or about 45% to about 95%, or about 50% to about 95%, or about 55% to about 95%, or about 60% to about 95%, or about 65% to about 95%, or about 70% to about 95%, or about 75% to about 95%, or about 80% to about 95%, or about 85% to about 95%, or about 90% to about 95%, or 20% to about 90%, or about 25% to about 90%, or about 30% to about 90%, or about 35% to about 90%, or about 40% to about 90%, or about 45% to about 90%, or about 50% to about 90%, or about 55% to about 90%, or about 60% to about 90%, or about 65% to about 90%, or about 70% to about 90%, or about 75% to about 90%, or about 80% to about 90%, or about 85% to about 90%, or 20% to about 85%, or about 25% to about 85%, or about 30% to about 85%, or about 35% to about 85%, or about 40% to about 85%, or about 45% to about 85%, or about 50% to about 85%, or about 55% to about 85%, or about 60% to about 85%, or about 65% to about 85%, or about 70% to about 85%, or about 75% to about 85%, or about 80% to about 85%, or 20% to about 80%, or about 25% to about 80%, or about 30% to about 80%, or about 35% to about 80%, or about 40% to about 80%, or about 45% to about 80%, or about 50% to about 80%, or about 55% to about 80%, or about 60% to about 80%, or about 65% to about 80%, or about 70% to about 80%, or about 75% to about 80%, or 20% to about 75%, or about 25% to about 75%, or about 30% to about 75%, or about 35% to about 75%, or about 40% to about 75%, or about 45% to about 75%, or about 50% to about 75%, or about 55% to about 75%, or about 60% to about 75%, or about 65% to about 75%, or about 70% to about 75%, or 20% to about 70%, or about 25% to about 70%, or about 30% to about 70%, or about 35% to about 70%, or about 40% to about 70%, or about 45% to about 70%, or about 50% to about 70%, or about 55% to about 70%, or about 60% to about 70%, or about 65% to about 70%, or 20% to about 65%, or about 25% to about 65%, or about 30% to about 65%, or about 35% to about 65%, or about 40% to about 65%, or about 45% to about 65%, or about 50% to about 65%, or about 55% to about 65%, or about 60% to about 65%, or 20% to about 60%, or about 25% to about 60%, or about 30% to about 60%, or about 35% to about 60%, or about 40% to about 65%, or about 45% to about 60%, or about 50% to about 60%, or about 55% to about 60%, or 20% to about 55%, or about 25% to about 55%, or about 30% to about 55%, or about 35% to about 55%, or about 40% to about 55%, or about 45% to about 55%, or about 50% to about 55%, or 20% to about 50%, or about 25% to about 50%, or about 30% to about 50%, or about 35% to about 50%, or about 40% to about 50%, or about 45% to about 50%, or 20% to about 45%, or about 25% to about 45%, or about 30% to about 45%, or about 35% to about 45%, or about 40% to about 45%, or 20% to about 40%, or about 25% to about 40%, or about 30% to about 40%, or about 35% to about 40%, or 20% to about 35%, or about 25% to about 35%, or about 30% to about 35%, or 20% to about 30%, or about 25% to about 30%, or 20% to about 25% of total surface of the solid bacterial growth support 10. In embodiments, such a microparticle coverage should provide a biomass development surface of about 1.57 to about 10 times larger than the biomass development surface of the solid bacterial growth support without microparticles. In embodiments, the microparticles may be made of a mineral material or a polymer. In embodiments, the microparticles may be a combination of microparticles made of a mineral material or a polymer. In embodiments, the mineral may be silica. In embodiments, the microparticles may be silica microspheres. The silica microsphere may full or hollow. They may be prepared from known techniques from precursors such as Tetraethyl orthosilicate, formally named tetraethoxysilane and abbreviated TEOS, Tetramethyl orthosilicate, and the likes. In embodiments, a microparticle coverage of at least 50% and up to 100% of total surface (i.e. about 50% to about 100%) may be preferably used for the removal of ammonia nitrogen in the wastewater. According to another embodiment, a microparticle coverage of at least 20% and up to about 50% of total surface (i.e. about 20% to about 50%) may be preferably used for the removal of the organic load in the wastewater.

According to another embodiment, there is disclosed a wastewater treatment system which comprises a solid bacterial growth support of the present invention in an enclosure. According to an embodiment, the wastewater treatment system may comprise a plurality of solid bacterial growth support of the present invention. The wastewater treatment system may be submerged fixed bed system, a fluidized system, or a combination thereof. The wastewater treatment system may further comprising an aeration system to promote growth of biomass, avoid clogging of the solid bacterial growth support and enhance the dispersion of the biomass inside and outside the treatment unit.

The aeration system can provide fine bubble, medium bubble or coarse bubble aeration or a combination thereof.

The diffusers of the aeration system are positioned underneath the enclosure. The aeration system consists of at least one diffuser. The diffuser can be made of steel, stainless steel, aluminum, plastic, rubber or ceramic.

The aeration system provides sufficient dissolved air, oxygen or a combination of gases to maintain a minimum of 2 mg O₂/L of dissolved oxygen in the water.

According to an embodiment, when the system of the present invention is used in an aerated pond or lagoon, the enclosure(s) used for organic load removal should be disposed in the last third of the first aerated pond or lagoon, to enhance the dispersion of the biomass inside and outside de treatment unit.

According to another embodiment, when the system of the present invention is used in an aerated pond or lagoon, the enclosure(s) used for ammoniacal nitrogen load removal should be disposed in the last aeration zone of the aerated pond or lagoon, to enhance the dispersion of the biomass inside and outside de treatment unit.

According to another embodiment, there is disclosed a method for wastewater treatment using the solid bacterial growth support 10 of the present invention, which comprises contacting wastewater with a plurality of the solid bacterial growth support 10 placed in an enclosure to be held together to form a treatment unit. The treatment unit will have a size dependent on the flow rate and contaminant loads in the wastewater.

According to an embodiment, the solid bacterial growth support 10 can be used in a submerged fixed bed or a fluidized system. In addition, the solid bacterial growth support 10 can be used in combination with an aeration system to promote growth of biomass, avoid clogging of the solid bacterial growth support 10 and enhance the dispersion of the biomass inside and outside the treatment unit.

The aeration system of the system may provide sufficient dissolved air, oxygen or a combination of gases to maintain a minimum of 2 mg O₂/L of dissolved oxygen in the water.

In embodiments, the solid bacterial growth support 10 may increases the rate of biomass growth in wastewater by at least about 50% in comparison to the rate of biomass growth in wastewater without the solid bacterial growth support. The solid bacterial growth support 10 coupled with the microparticles unexpectedly provides an organic load abatement capacity of at least about 41% (kg/day) higher than an organic load abatement capacity of the solid bacterial growth support without microparticles.

According to another embodiment, the biomass development surface of the solid bacterial growth support 10 being at least about 50% to about 100% may be used for the removal of ammonia nitrogen in wastewater. According to another embodiment, a biomass development surface of about 20% and up to about 50% may be used for the removal of the organic load in wastewater. Once coupled with the microparticles, the solid bacterial growth support 10 unexpectedly provides an ammonia nitrogen removal capacity of at least about 62% (kg/day) higher than an ammonia nitrogen removal capacity of the solid bacterial growth support without microparticles.

According to another embodiment, the solid bacterial growth support 10 may be used submerged in a first pond or lagoon of a water treatment plant to remove the organic load. In this context, the solid bacterial growth support 10 may provide removal up to 98% of a 5-day biochemical oxygen demand (BOD5) load, for treatment of BOD5 of about 150 mg/L up to about 20 000 mg/L. The solid bacterial growth support 10 may provide removal up to 99% of a total suspended solids (TSS) load.

According to another embodiment, the solid bacterial growth support 10 may be used submerged in an anoxic portion of a pond or lagoon of a water treatment plant for the removal of ammonia nitrogen load. The solid bacterial growth support 10 may provide removal up to 99% of an ammonia nitrogen load, for an organic load less than about 10 mg/L in concentration. In embodiments, this method may be for treatment of ammoniacal nitrogen of from about 1 mg/L up to about 50 mg/L.

In embodiments, the method of the present invention may be performed in liquid water at temperature about 0° C. to about 40° C. In embodiments, the methods of the present invention may be performed in liquid water at a temperature of up to about 3° C., or about 4° C., or about 5° C., or about 6° C., or about 7° C., or about 8° C., or about 9° C., or about 10° C., or about 11° C., or about 12° C., or about 13° C., or about 14° C., or about 15° C., or about 16° C., or about 17° C., or about 18° C., or about 19° C., or about 20° C., or about 21° C., or about 22° C., or about 23° C., or about 24° C., or about 25° C., or about 26° C., or about 27° C., or about 28° C., or about 29° C., or about 30° C., or about 31° C., or about 32° C., or about 33° C., or about 34° C., or about 35° C., or about 36° C., or about 37° C., or about 38° C., or about 39° C., and up to no more than 40° C. The temperature may be from about 0° C. to about 40° C., or from about 1° C. to about 40° C., or from about 2° C. to about 40° C., or from about 3° C. to about 40° C., or from about 4° C. to about 40° C., or from about 5° C. to about 40° C., or from about 6° C. to about 40° C., or from about 7° C. to about 40° C., or from about 8° C. to about 40° C., or from about 9° C. to about 40° C., or from about 10° C. to about 40° C., or from about 15° C. to about 40° C., or from about 20° C. to about 40° C., or from about 25° C. to about 40° C., or from about 30° C. to about 40° C., or from about 35° C. to about 40° C., or from about 0° C. to about 35° C., or from about 1° C. to about 35° C., or from about 2° C. to about 35° C., or from about 3° C. to about 35° C., or from about 4° C. to about 35° C., or from about 5° C. to about 35° C., or from about 6° C. to about 35° C., or from about 7° C. to about 35° C., or from about 8° C. to about 35° C., or from about 9° C. to about 35° C., or from about 10° C. to about 35° C., or from about 15° C. to about 35° C., or from about 20° C. to about 35° C., or from about 25° C. to about 35° C., or from about 30° C. to about 35° C., or from about 0° C. to about 30° C., or from about 1° C. to about 30° C., or from about 2° C. to about 30° C., or from about 3° C. to about 30° C., or from about 4° C. to about 30° C., or from about 5° C. to about 30° C., or from about 6° C. to about 30° C., or from about 7° C. to about 30° C., or from about 8° C. to about 30° C., or from about 9° C. to about 30° C., or from about 10° C. to about 30° C., or from about 15° C. to about 30° C., or from about 20° C. to about 30° C., or from about 25° C. to about 30° C., or from about 0° C. to about 25° C., or from about 1° C. to about 25° C., or from about 2° C. to about 25° C., or from about 3° C. to about 25° C., or from about 4° C. to about 25° C., or from about 5° C. to about 25° C., or from about 6° C. to about 25° C., or from about 7° C. to about 25° C., or from about 8° C. to about 25° C., or from about 9° C. to about 25° C., or from about 10° C. to about 25° C., or from about 15° C. to about 25° C., or from about 20° C. to about 25° C., or from about 0° C. to about 20° C., or from about 1° C. to about 20° C., or from about 2° C. to about 20° C., or from about 3° C. to about 20° C., or from about 4° C. to about 20° C., or from about 5° C. to about 20° C., or from about 6° C. to about 20° C., or from about 7° C. to about 20° C., or from about 8° C. to about 20° C., or from about 9° C. to about 20° C., or from about 10° C. to about 20° C., or from about 15° C. to about 20° C., or from about 0° C. to about 15° C., or from about 1° C. to about 15° C., or from about 2° C. to about 15° C., or from about 3° C. to about 15° C., or from about 4° C. to about 15° C., or from about 5° C. to about 15° C., or from about 6° C. to about 15° C., or from about 7° C. to about 15° C., or from about 8° C. to about 15° C., or from about 9° C. to about 15° C., or from about 10° C. to about 15° C., or from about 0° C. to about 10° C., or from about 1° C. to about 10° C., or from about 2° C. to about 10° C., or from about 3° C. to about 10° C., or from about 4° C. to about 10° C., or from about 5° C. to about 10° C., or from about 6° C. to about 10° C., or from about 7° C. to about 10° C., or from about 8° C. to about 10° C., or from about 9° C. to about 10° C., or from about 0° C. to about 9° C., or from about 1° C. to about 9° C., or from about 2° C. to about 9° C., or from about 3° C. to about 9° C., or from about 4° C. to about 9° C., or from about 5° C. to about 9° C., or from about 6° C. to about 9° C., or from about 7° C. to about 9° C., or from about 8° C. to about 9° C., or from about 0° C. to about 8° C., or from about 1° C. to about 8° C., or from about 2° C. to about 8° C., or from about 3° C. to about 8° C., or from about 4° C. to about 8° C., or from about 5° C. to about 8° C., or from about 6° C. to about 8° C., or from about 7° C. to about 8° C., or from about 0° C. to about 7° C., or from about 1° C. to about 7° C., or from about 2° C. to about 7° C., or from about 3° C. to about 7° C., or from about 4° C. to about 7° C., or from about 5° C. to about 7° C., or from about 6° C. to about 7° C., or from about 0° C. to about 6° C., or from about 1° C. to about 6° C., or from about 2° C. to about 6° C., or from about 3° C. to about 6° C., or from about 4° C. to about 6° C., or from about 5° C. to about 6° C., or from about 0° C. to about 5° C., or from about 1° C. to about 5° C., or from about 2° C. to about 5° C., or from about 3° C. to about 5° C., or from about 4° C. to about 5° C., or from about 0° C. to about 4° C., or from about 1° C. to about 4° C., or from about 2° C. to about 4° C., or from about 3° C. to about 4° C., or from about 0° C. to about 3° C., or from about 1° C. to about 3° C., or from about 2° C. to about 3° C., or from about 0° C. to about 2° C., or from about 1° C. to about 2° C., or from about 0° C. to about 1° C. Unexpectedly, the solid bacterial growth support of the present invention allows the removal of ammoniacal nitrogen even in very cold water even at less than 4° C. without heating the influent.

The wastewater to be treated may contain organic, non-organic, and metallic contaminants, biological oxygen demand over 5 days (BOD5), soluble BOD5, chemical oxygen demand (COD), total suspended solids (TSS), phosphorus, ammonia nitrogen, nitrite, nitrate, fecal coliforms, total coliforms, absorbable organic halogens, metals. The present invention makes no use of chemicals for the treatment of the wastewater and may be used in municipal as well as industrial settings, for example agricultural settings, pulp and paper settings, mining and oil settings.

The solid bacterial growth support 10 may be of any suitable shape and make, and is adapted to sustain the growth of microorganisms (live bacteria cultures, live microorganisms, live biomass and the like) and/or substrates that will capture toxins that biological treatment cannot degrade, such as metal atoms. The live bacteria cultures, the live biomass may degrade the polluting compounds present in the wastewater. Furthermore, the solid bacterial growth support 10 is capable of contacting the wastewater, retain the bacteria therein and releasing a by-product in suspension, namely the biomass, in the volume of wastewater being treated, thereby maintaining and/or renewing the bacterial activity in the volume of wastewater. The bacteria/biomass, when it dies, naturally detaches from the solid bacterial growth support, which leads to natural regeneration of live bacteria and/or biomass on the latter.

According to another embodiment, the solid bacterial growth support 10 may further include at least one of a live bacteria culture, a live biomass, or both. The live bacteria culture, live biomass, or both may be present in the solid bacterial growth support to provide additional bacteria and/or biomass. This may be done for example to add specific bacteria and/or biomass for the destruction or biodegradation of nitrates (e.g. ammoniacal nitrogen) and other undesirable chemicals present in the wastewater.

According to another embodiment, there is described a method of treating wastewater which may include the step of maintaining and retaining in a volume of wastewater a live biomass in the solid bacterial growth support 10 for a treatment of the wastewater as presented above. In use, an aeration system such as an oxygen diffuser, may be used to provide oxygen to promote growth of the live bacteria culture, the live biomass, or the like. In this case, the aeration system can play two roles. First, it provides oxygen to the bacteria or biomass that is living on the solid bacterial growth support, since oxygen is needed to sustain life which biodegrades pollutants. Second, the flow of air bubbles within the solid bacterial growth support ensures that there is no clogging or excessive accumulation or depletion of living matter in specific parts of the solid bacterial growth support; in other words, it makes the spatial distribution of bacteria and biomass more even, thereby removing preferential paths that may have formed inside the solid bacterial growth support 10. The existence of preferential paths is undesirable since it means that matter to be degraded may be in contact with only a small fraction of the solid bacterial growth support, and some parts of the solid bacterial growth support may not be oxygenated well, which can cause biochemical disequilibrium.

Moreover, the aeration system may provide a movement and ensure that the amount of biomass does not become too large. Too much biomass on the solid bacterial growth support 10 leads to clogging risks, and increases the risk of creating anaerobic zones in the enclosures. Optimally, a thin layer of biomass all over the solid bacterial growth support 10 should be present. The live bacteria, the live biomass of the method of treating wastewater may adhere to the solid bacterial growth support 10.

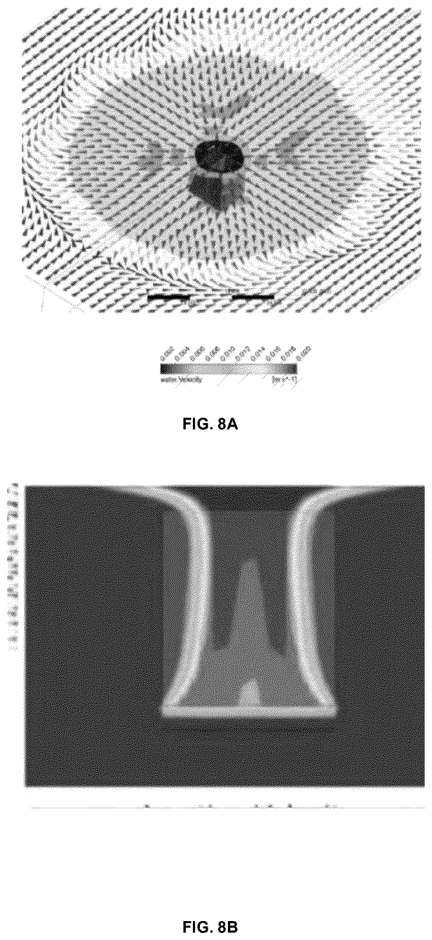

According to an embodiment, the enclosure(s) is/are configured to receive a volume of wastewater flowing therethrough from the pond or lagoon over a treatment period, and to treat substantially an entire volume of water flowing through the pond or lagoon over time, from the release in the wastewater within the enclosure, and provide a radiation effect of the treatment effect of the system beyond the enclosure(s). In embodiments, the system may be configured to cross a whole width of the pond or lagoon. In embodiments, the system is capable of treating substantially the entire volume of water flowing through the pond or lagoon over time through its positioning in the natural hydraulic flow of the pond or lagoon. Furthermore, the system of the present invention has a radiation effect, where the treatment effect of the system of the present invention radiates from the system, as shown in FIG. 8, and documented in ML: Howland, W. E. (1958). Flow Over Porous Media as in a Trickling Filter. Proc. 12th Ind. Waste Conf., May 13, 14 and 15, 1957, Extension Series No. 94, Engineering Bulletin 42(3), D. E. Bloodgood, ed., Purdue University, Lafayette, IN, incorporated herein by reference. FIG. 8 illustrates the impact on the flow velocity through the system of the present invention. That is, beyond the enclosure itself, the effect of the system of the present invention is still present. The system of the present invention does not need to have an enclosure that goes all the way to the bottom of the pond or lagoon in order to treat substantially the entire volume of water flowing through the pond or lagoon over time. Indeed, in some embodiments, this is disadvantageous, as it would provide insufficient space for the sludge to come off the system and rest at the bottom thereof. By having space under the system 10, and by not being in contact with the bottom of the pond or lagoon, the system 10 of the present invention is not affected by the sludge produced by the system and the pond itself.

According to another embodiment, the treatment of wastewater may be optimized by providing the volume of wastewater with concentrations of bacteria, biomass or both, that provide an optimal degradation of the polluting compounds. Therefore, the method of treating wastewater may further include steps of seeding the volume of wastewater, with an exogenous live bacteria culture, or the like, exogenous live biomass, or both. These supplementations in exogenous live bacteria culture or exogenous live biomass may be performed to optimize the efficiency of the wastewater treatment plant. Moreover, the supplementation or seeding may be necessary to introduce new strains of bacteria or biomass in order to degrade polluting compounds that the live bacteria culture, the live biomass, or both, endogenous to the wastewater treatment plant are less effective at or unable of degrading.

According to another embodiment, in the methods of the present invention, the solid bacterial growth support 10 may be used submerged in a first pond or lagoon of a water treatment plant to remove the organic load. In this context, the solid bacterial growth support 10 may provide removal up to 98% of a 5-day biochemical oxygen demand (BOD5) load, for treatment of BOD5 of about 150 mg/L up to about 20 000 mg/L. In this context, the solid bacterial growth support 10 may provide removal up to 99% of a total suspended solids (TSS) load.

According to another embodiment, in the methods of the present invention, the solid bacterial growth support 10 may be used submerged in an anoxic portion of a pond or lagoon of a water treatment plant for the removal of ammonia nitrogen load. The solid bacterial growth support 10 may provide removal up to 99% of an ammonia nitrogen load, for an organic load less than about 10 mg/L in concentration. In embodiments, this method may be for treatment of ammoniacal nitrogen of from about 1 mg/L up to about 50 mg/L.

In embodiments, the methods of the present invention may be performed in liquid water at a temperature as indicated above.

While preferred embodiments have been described above and illustrated in the accompanying drawings, it will be evident to those skilled in the art that modifications may be made without departing from this disclosure. Such modifications are considered as possible variants comprised in the scope of the disclosure.

The present invention will be more readily understood by referring to the following examples which are given to illustrate the invention rather than to limit its scope.

### EXAMPLE 1

### Detailed Performances of the Solid Bacterial Growth Support in Wastewater Treatment

According to the experimental testing performed, each installation is built to remove up to:
98% of the 5-day biochemical oxygen demand (BOD5) load; and
99% of the total suspended solids (TSS) load;

These results are achievable when the solid bacterial growth support is completely submerged in the first pond or lagoon of an existing wastewater treatment plant to remove the organic load.

The results were obtained in cold water of 7° C. or less.

The range of use of the media allows to treat concentrations from 150 mg/L up to 20 000 mg/L in BOD5.

According to the experimental testing performed, each installation is also built to remove up to;
98% of ammonia nitrogen load;

The microspheres are of a diameter of about 20 to about 50 μm, and were sprayed to provide a microparticle coverage of about 100% of the total surface of the solid bacterial growth support, which provided a biomass development surface of about 800 to about 1000 m²/m³ for use in a fixed bed system.

These results are achievable when the solid bacterial growth support is completely submerged in the anoxic portion of the pond or lagoon of an existing wastewater treatment plant for the removal of ammonia nitrogen load.

The results were obtained in cold water of 7° C. or less.

The range of use of the media allows to treat concentrations from 1 mg/L up to 50 mg/L in ammoniacal nitrogen.

### Results

All analyses were performed in an independent laboratory certified by the province of Quebec.

### Municipal Wastewater

TABLE 1
5-day biochemical oxygen demand (BOD5)

| Date | Input (mg/L) | Output (mg/L) | % of reduction |
|---|---|---|---|
| 19-jan | 114 | 3 | 97.37% |
| 25-jan | 102 | 3 | 97.06% |
| 31-jan | 67 | 2 | 97.01% |
| 03-febr | 76 | 2 | 97.37% |
| 09-feb | 93 | 2 | 97.85% |
| 10-feb | 112 | 2 | 98.21% |
| 14-feb | 116 | 2 | 98.28% |
| 15-feb | 143 | 2 | 98.60% |

TABLE 2
Total suspended solids (TSS)

| Date | Input (mg/L) | Output (mg/L) | % of reduction |
|---|---|---|---|
| 09-feb | 396 | 24 | 93.94% |
| 10-feb | 390 | 15 | 96.15% |
| 14-feb | 346 | 6 | 98.27% |
| 15-feb | 271 | 9 | 96.68% |
| 22-feb | 210 | 5 | 97.62% |
| 24-feb | 516 | 5 | 99.03% |
| 01-mar | 232 | 5 | 97.84% |
| 02-mar | 197 | 5 | 97.46% |

TABLE 3
Ammoniacal nitrogen

| Date | Input (mg/L) | Output (mg/L) | % of reduction |
|---|---|---|---|
| 19-jan | 22.3 | 0.15 | 99.33% |
| 25-jan | 22.1 | 0.46 | 97.92% |
| 31-jan | 26.1 | 0.3 | 98.85% |
| 03-feb | 26.1 | 0.29 | 98.89% |
| 09-feb | 26.8 | 0.145 | 99.46% |
| 10-feb | 25.8 | 0.14 | 99.46% |
| 14-feb | 27.1 | 0.07 | 99.74% |
| 15-feb | 25.6 | 0.08 | 99.69% |
| 22-feb | 12.6 | 0.03 | 99.76% |
| 24-feb | 15.5 | 0.02 | 99.87% |
| 01-mar | 15.1 | 0.02 | 99.87% |
| 02-mar | 15.3 | 0.02 | 99.87% |
| 07-mar | 16.6 | 0.07 | 99.58% |

### Results

All analyses were performed in an independent laboratory certified by the province of Quebec.

### EXAMPLE 2

### Detailed Performances of the Solid Bacterial Growth Support in Wastewater Treatment for Removal of Ammoniacal Nitrogen

According to the experimental testing performed, each installation is built to remove up to 98% of daily ammoniacal nitrogen (i.e. ammonia nitrogen load) present in wastewater. These results are achievable when the solid bacterial growth support is completely submerged in the third or fourth aerated pond or lagoon of an existing wastewater treatment plant comprising at least three or four aerated ponds or lagoon. The results were obtained in water temperatures between about 20° C. and as low as 3° C.

These results are achievable when the solid bacterial growth support is completely submerged in the anoxic portion of the pond or lagoon of an existing wastewater treatment plant. The targeted ammonia nitrogen load (also known as environmental release targets) must be less than 5 mg N/L in concentration and may be as low as 1 mg N/L in some jurisdictions.

This experiment provides a comparison between the aerated ponds without treatment system, a wastewater treatment system comprising a standard polyethylene media (see FIG. 2 for an illustration of the shape) and a system with the same media but with a microparticles (i.e. microspheres) layer according to the present invention (i.e. see FIG. 2). The system, when present, also comprises an aeration system providing fine bubbles under the media, at a rate of 6 mg O₂/L. The microspheres were incorporated on the surface of the solid bacterial growth support by spraying them on the mesh cylinders. The microspheres are of a diameter of about 20 to about 50 μm, and were sprayed to provide a microparticle coverage of about 50% of the total surface of the solid bacterial growth support, which provided a biomass development surface of about 300 to about 500 m²/m³ for use in a fixed bed system. The system is installed, in each instance, in the third pond, which is the last aerated zone of 4 ponds used in the treatment of municipal wastewater. Table 4 below presents the performance on the removal of ammoniacal nitrogen (NH₄⁺). The influent values are the ammoniacal nitrogen load coming into the third pond, not the influent from the water pumping station into the first aerated pond. The results presented are average of daily measurements taken over a 12-month period.

TABLE 4
Ammoniacal nitrogen

| | | Effluent | | | |
|---|---|---|---|---|---|
| | | from | | | Effluent |
| | | aerated | | Effluent | Media |
| | | ponds | Effluent | standard | present |
| | Affluent | alone | MBBR | media | invention |
| Parameters | (mg/L) | (mg/L) | (mg/L) | (mg/L) | (mg/L) |
| NH₄⁺ (mg N/L) | 15.21 | 8.08 | 3.6 | 5.59 | 0.37 |
| average in | | | | | |
| summer | | | | | |
| NH₄⁺ (mg N/L) | 13.61 | 15.04 | 11.2 | 12.64 | 0.56 |
| average in winter | | | | | |
| Average | 19.5 | 17.8 | 17.8 | 17.8 | 17.8 |
| temperature | | | | | |
| summer (° C.) | | | | | |
| Average | 15.8 | 3.2 | 3.2 | 3.2 | 3.2 |
| temperature | | | | | |
| winter (° C.) | | | | | |

During summer, the aerated ponds are able to decrease ammonia nitrogen loads by about 1.9-fold, and the use of a wastewater treatment system does improve treatment performance (about 2.72-fold versus the untreated influent). Unexpectedly, use of the media of the present invention in identical conditions results in a reduction of the ammonia nitrogen loads by about 41-fold compared to the untreated influent, or by 15-fold when compared to the standard polyethylene media without a microparticles layer. During winter, aerated ponds are notoriously poor performing for the removal of ammonia nitrogen loads, as may be seen from their performance for ponds alone and even with the standard polyethylene media without a microparticles layer, which is hardly improving treatment performance. Unexpectedly, use of the media of the present invention in identical conditions results in a reduction of the ammonia nitrogen loads by about 24-fold compared to the untreated influent, or by 23-fold when compared to the standard polyethylene media without a microparticles layer. These results were completely surprising and unexpected.

The results for ammoniacal nitrogen removal of the system comprising the media of the present invention may be also compared to a biological reactor technology comprising a fluidized bed (MBBR). A MBBR does not perform well in cold water. To have equivalent performance in winter and summer, the influent must be heated in winter. This is an important difference from the system of the present invention, since heating is not required with it. For the volumes of water treated with the system of the present invention, (several hundreds to thousands of cubic meters per day), it would be very challenging to heat the influent. The MBBR can therefore be compared to the system of the present invention only for small volumes of less than 100 m³/d, for example.

Referring to Table 3, in summer, use of the media of the present invention results in a reduction of the ammonia nitrogen loads by about 9.7-fold compared to the MBBR-treated influent. During winter, the MBBR performance is severely decreased, and use of the media of the present invention in identical conditions results in a reduction of the ammonia nitrogen loads by about 20-fold compared to the MBBR influent. These results were completely surprising and unexpected.

### EXAMPLE 3

### Detailed Performances of the Solid Bacterial Growth Support in Wastewater Treatment for Removal of Ammoniacal Nitrogen

According to the experimental testing performed, each installation is built to remove up to 98% of daily ammoniacal nitrogen (i.e. ammonia nitrogen load) present in wastewater from the milk industry which comprises a high ammoniacal nitrogen load. These results are achievable when the solid bacterial growth support is completely submerged in the third or fourth aerated pond or lagoon of an existing wastewater treatment plant comprising at least three or four aerated ponds or lagoon. The results were obtained in water temperatures between about 20° C. and as low as 3° C.

These results are achievable when the solid bacterial growth support is completely submerged in the anoxic portion of the pond or lagoon of an existing wastewater treatment plant. The targeted ammonia nitrogen load (also known as environmental release targets) must be less than 5 mg N/L in concentration and may be as low as 1 mg N/L in some jurisdictions.

This experiment provides a comparison between the aerated ponds without treatment system, a wastewater treatment system comprising a standard polyethylene media (see FIG. 2 for an illustration of the shape) and a system with the same media but with a microparticles (i.e. microspheres) layer according to the present invention (i.e. see FIG. 2). The system, when present, also comprises an aeration system providing fine bubbles under the media, at a rate of 6 mg O₂/L. The microspheres were incorporated on the surface of the solid bacterial growth support by spraying them on the mesh cylinders. The microspheres are of a diameter of about 20 to about 50 μm, and were sprayed to provide a microparticle coverage of about 75% of the total surface of the solid bacterial growth support, which provided a biomass development surface of about 500 to about 1000 m²/m³ for use in a fixed bed system. The system is installed, in each instance, in the third pond, which is the last aerated zone of 4 ponds used in the treatment of municipal wastewater. Table 5 below presents the performance on the removal of ammoniacal nitrogen (NH₄⁺). The influent values are the ammoniacal nitrogen load coming into the third pond, not the influent from the water pumping station into the first aerated pond. The results presented are average of daily measurements taken over a 25-week period.

TABLE 5
Ammoniacal nitrogen

| | | Effluent | | |
|---|---|---|---|---|
| | | from | | |
| | | aerated | Effluent | Effluent |
| | | ponds | standard | Media present |
| | Affluent | alone | media | invention |
| Parameters | (mg/L) | (mg/L) | (mg/L) | (mg/L) |
| NH₄⁺ (mg N/L) | 28.4 | 9.9 | 8.3 | 0.38 |
| average in | | | | |
| summer | | | | |
| NH₄⁺ (mg N/L) | 24.6 | 23.4 | 19.5 | 0.48 |
| average in winter | | | | |
| Average | 27.3 | 20.6 | 20.6 | 20.6 |
| temperature | | | | |
| summer (° C.) | | | | |
| Average | 26.1 | 18.0 | 18.0 | 18.0 |
| temperature | | | | |
| winter (° C.) | | | | |

TABLE 6
Performance over 25-week period

| | | Effluent | | | |
|---|---|---|---|---|---|
| | | from | | Effluent | |
| | | aerated | Effluent | Media | % |
| | | ponds | standard | present | Removal |
| | Affluent | alone | media | invention | present |
| Date | (mg/L) | (mg/L) | (mg/L) | (mg/L) | invention |
| 11 Sep. 2019 | 28.6 | 7.1 | 6.0 | 0.23 | 99% |
| 18 Sep. 2019 | 29.8 | 9.3 | 7.9 | 0.33 | 99% |
| 25 Sep. 2019 | 32.1 | 11.3 | 9.6 | 0.35 | 99% |
| 2 Oct. 2019 | 27.9 | 14.2 | 10.7 | 0.5 | 98% |
| 9 Oct. 2019 | 27.2 | 9.5 | 8.1 | 0.36 | 99% |
| 16 Oct. 2019 | 26.9 | 8.4 | 7.1 | 0.27 | 99% |
| 23 Oct. 2019 | 30 | 9.2 | 7.8 | 0.31 | 99% |
| 30 Oct. 2019 | 24.9 | 10.5 | 8.9 | 0.44 | 98% |
| 6 Nov. 2019 | 25.2 | 26.1 | 19.6 | 0.38 | 98% |
| 13 Nov. 2019 | 24.4 | 23 | 19.6 | 0.39 | 98% |
| 20 Nov. 2019 | 22 | 23.4 | 19.9 | 0.33 | 99% |
| 27 Nov. 2019 | 22.1 | 20.7 | 17.6 | 0.34 | 98% |
| 4 Dec. 2019 | 26.3 | 24.6 | 18.5 | 0.41 | 98% |
| 11 Dec. 2019 | 24.8 | 22 | 18.7 | 0.6 | 98% |
| 18 Dec. 2019 | 24.7 | 22 | 18.7 | 0.57 | 98% |
| 25 Dec. 2019 | 25 | 20.9 | 17.8 | 0.67 | 97% |
| 1 Jan. 2020 | 24.1 | 24 | 20.4 | 0.5 | 98% |
| 8 Jan. 2020 | 28.1 | 29.1 | 21.8 | 0.7 | 98% |
| 15 Jan. 2020 | 24.9 | 23.3 | 19.8 | 0.52 | 98% |
| 22 Jan. 2020 | 25.8 | 23.6 | 20.1 | 0.6 | 98% |
| 29 Jan. 2020 | 25.5 | 24.3 | 20.7 | 0.49 | 98% |
| 5 Feb. 2020 | 24.6 | 24 | 20.4 | 0.44 | 98% |
| 12 Feb. 2020 | 24.1 | 22.5 | 19.1 | 0.51 | 98% |
| 19 Feb. 2020 | 23.2 | 22.4 | 19.0 | 0.36 | 98% |
| 26 Feb. 2020 | 24 | 23.1 | 19.6 | 0.4 | 98% |

During summer, the aerated ponds are able to decrease ammonia nitrogen loads by about 2.9-fold, and the use of a wastewater treatment system does improve treatment performance (about 3,42-fold versus the untreated influent). Unexpectedly, use of the media of the present invention in identical conditions results in a reduction of the ammonia nitrogen loads by about 75-fold compared to the untreated influent, or by 22-fold when compared to the standard polyethylene media without a microparticles layer. During winter, aerated ponds are notoriously poor performing for the removal of ammonia nitrogen loads, as may be seen from their performance for ponds alone and even with the standard polyethylene media without a microparticles layer, which is hardly improving treatment performance. Unexpectedly, use of the media of the present invention in identical conditions results in a reduction of the ammonia nitrogen loads by about 57-fold compared to the untreated influent, or by 41-fold when compared to the standard polyethylene media without a microparticles layer. These results were completely surprising and unexpected.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for wastewater treatment using a solid bacterial growth support or a wastewater treatment system comprising said solid bacterial growth support, said solid bacterial growth support comprising:
a body comprising at least one surface comprising a plurality of microparticles coupled to and partly inserted on said at least one surface, providing a biomass development surface of about 1.57 to 10 times larger than the biomass development surface of said body without microparticles,
said solid bacterial growth support having a microparticle coverage of at least 50% of total surface for removal of ammoniacal nitrogen in said wastewater,
said solid bacterial growth support providing a biomass development surface of about 100 to 600 m²/m³ when used as a fixed bed bacterial support and/or provides a biomass development surface of about 1250 to 3000 m²/m³ when used as a fluidized bed bacterial support,
the method comprising contacting an influent of said wastewater with a plurality of said solid bacterial growth support or said wastewater treatment system, placed in an enclosure to be held together to form a treatment unit, said treatment unit having a size dependent on the flow rate and contaminant loads in said wastewater, said solid bacterial growth support being completely submerged in said wastewater, and
said method providing removal of up to 99% ammoniacal nitrogen at a wastewater temperature of from about 0° C. to about 10° C., without heating of the influent
wherein.

2. The method of claim 1, wherein said solid bacterial growth support further comprises solid bacterial growth support having a microparticle coverage of up to about 50% of the total surface of said solid bacterial growth support for removal of an organic load in said wastewater, which provides up to 98% removal of said organic load in said wastewater.

3. The method of claim 1, wherein the wastewater treatment system comprises a submerged fixed bed system, a fluidized system, or a combination thereof.

4. The method of claim 1, wherein said microparticles have a diameter of about 1 to about 50 μm, comprise a hollow microparticle, a full microparticle, or a combination thereof, have a plurality of pores and/or asperities on a surface thereof, or a combination thereof.

5. The method of claim 1, wherein said solid bacterial growth support comprises a plurality of surfaces and wherein said solid bacterial growth support is made of plastic, carbonized bone powder, a proteinaceous matter, or a combination thereof.

6. The method of claim 1, wherein said body is a plurality of mesh hollow bodies, each hollow body having an external and an internal surface, and a plurality of openings therethrough configured to permit circulation of a fluid, said mesh hollow bodies being substantially elongated and configured parallel to one another along their length to form said solid bacterial growth support and provide an exterior surface of said bacterial growth support, and said plurality of microparticles is coupled to and partly inserted on said exterior surface of said solid bacterial growth support and on said external and said internal surface of said mesh hollow bodies.

7. The method of claim 6, wherein said hollow body is a cylinder, a rectangular prism, a rectangular cuboid, a triangular prism, a plurality of mesh hollow body, or a combination thereof.

8. The method of claim 7, wherein said plurality of mesh hollow body form a block-shaped solid bacterial growth support, comprises about 100 to 300 of said mesh hollow body and wherein said mesh hollow body is a cylinder having a diameter of about 1 to 3 cm.

9. The method of claim 8, wherein said solid bacterial growth support or said wastewater treatment system is submerged in a first treatment aerated pond or lagoon for organic load removal or wherein said solid bacterial growth support or said wastewater treatment system is installed in the last aerated zone of a treatment aerated pond or lagoon for ammoniacal nitrogen load removal.

10. The method of claim 1, wherein said solid bacterial growth support or said wastewater treatment system is used in combination with an aeration system to promote growth of biomass, avoid clogging of said solid bacterial growth support and enhance the dispersion of the biomass inside and outside the treatment unit.

11. The method of claim 1, wherein said solid bacterial growth support increases the rate of biomass growth in wastewater by at least about 50% in comparison to the rate of biomass growth in wastewater without said solid bacterial growth support.

12. The method of claim 1, wherein said solid bacterial growth support provides an organic load abatement capacity of at least about 41% (kg/day) higher than an organic load abatement capacity of a solid bacterial growth support without microparticles.

13. The method of claim 2, wherein said solid bacterial growth support has a microparticle coverage of about 20% and up to about 50% of total surface for removal of organic load in said wastewater.

14. The method of claim 1, wherein said solid bacterial growth support provides an ammoniacal nitrogen removal capacity of at least about 62% (kg/day) higher than an ammoniacal nitrogen removal capacity of a solid bacterial growth support without microparticles.

15. The method of claim 1, wherein said solid bacterial growth support is submerged in the last third of the first treatment aerated pond or lagoon to remove the organic load.

16. The method of claim 2, wherein said method is for removal of up to 98% of a 5 day biochemical oxygen demand (BOD5) load, for treatment of BOD5 of about 150 mg/L up to about 20 000 mg/L, for removal of up to 99% of a total suspended solids (TSS) load or a combination thereof.

17. The method of claim 1, wherein said solid bacterial growth support is submerged in an anoxic portion of a pond or lagoon of a water treatment plant for the removal of ammoniacal nitrogen load.

18. The method of claim 1, wherein said method is for removal of up to 99% ammoniacal nitrogen at a concentration of from about 1 mg/L up to about 50 mg/L.

19. The method of claim 1, wherein an aeration system of said wastewater treatment system provides sufficient dissolved air, oxygen or a combination of gases to maintain a minimum of 2 mg O₂/L of dissolved oxygen in the water.
